(19) United States
(12) Patent Application Publication
(10) Pub. No.: US 2007/0277908 A1
(43) Pub. Date: Dec. 6, 2007

(54) Non-Corrosive Auxiliary Agents For Soldering Aluminium

(75) Inventors: Ulrich Seseke-Koyro, Isernhagen (DE); Andreas Becker, Lachendorf (DE)

Correspondence Address: CONNOLLY BOVE LODGE & HUTZ, LLP, P O BOX 2207, WILMINGTON, DE, 19899, US

(73) Assignee: SOLVAY FLUOR GMBH, HANNOVER (DE)

(21) Appl. No.: 10/593,500

(22) PCT Filed: Mar. 11, 2005
(86) PCT No.: PCT/EP05/02609

§ 371 Date: Apr. 27, 2007

(30) Foreign Application Priority Data
Mar. 20, 2004 (DE) 10 2004 013 841.9
Jun. 9, 2004 (DE) 10 2004 028 093.2

(51) Int. Cl. B23K 35/34; B23K 35/36; C01F 7/04; C01F 7/54; C22B 21/06

(52) U.S. Cl. 148/24

(57) ABSTRACT

The invention relates to noncorrosive auxiliaries for soldering aluminium and for upgrading aluminium alloys based on alkali metal fluoroaluminates, their preparation and their use. According to the invention, the noncorrosive auxiliaries contain metallates. To form the metallates, metal compounds of the elements of main groups 2 to 5 of the PTE or of the transition elements in the form of their salts or oxides are used as reactants. In particular, their halides, nitrates, carbonates, sulphates, phosphates, borates, hexafluorosilicates or oxides, for example, are used. According to the invention, the metal compounds are introduced into the reaction mixture of hydrofluoric acid and/or hydrated alumina and/or alkali metal compound, with the point in time when the metal compound is added being able to be varied as a function of the desired degree of functionalization of the surface.

The invention relates to noncorrosive auxiliaries based on alkali metal fluoroaluminates for soldering aluminium and/or for upgrading aluminium alloys, the preparation of the auxiliaries and their use as fluxes for soldering components composed of aluminium and aluminium alloys or as additive for introducing metals into aluminium alloys.

Assemblies of parts composed of aluminium or aluminium alloys can be produced by soldering these parts together. A flux based on fluoroaluminate which frees the surface of the components to be soldered to one another of adhering oxidic materials is usually used for this purpose.

Fluxes based on potassium fluoroaluminate are particularly suitable for the soldering of aluminium or low-magnesium aluminium alloys. Such a process is disclosed in the British Patent GB 1 438 955. The preparation of appropriate fluxes is described, for example, by Willenberg, U.S. Pat. No. 4,428,920 and Meshri, U.S. Pat. No. 5,318,764 and also Kawase, U.S. Pat. No. 4,579,605. Magnesium-containing aluminium alloys can be soldered with good results using a flux composition containing caesium. The addition of particular metal silicates in particular amounts can make the solder metal superfluous.

In carrying out soldering, the flux and a solder metal are applied to the components to be joined. The flux can, for example, be applied in the form of a slurry, as an aqueous suspension, as a paste or powder. The components are placed together in the desired position and heated. The flux firstly melts and cleans the surface, and then the solder melts. The parts are subsequently allowed to cool.

It is an object of the invention to provide noncorrosive auxiliaries which can be used as flux or for upgrading alloys and also a process for preparing these novel noncorrosive auxiliaries based on alkali metal fluoroaluminates. The novel auxiliaries should effect, for example, an improvement of the soldering flux and an improvement in the quality of the surface.

The noncorrosive auxiliaries of the invention are characterized by a content of coprecipitated or mixed-in metallates.

The preparation of these auxiliaries based on alkali metal fluoroaluminates is carried out by means of preparative methods known per se by bringing the reactants hydrogen fluoride, aluminium hydroxide (hydrated alumina) and alkali metal compound, preferably alkali metal hydroxide and also at least one metal compound, preferably in the form of its salts, e.g. halides, nitrates, carbonates, sulphates, phosphates, borates or hexafluorosilicates, and/or its oxides into contact with one another.

The auxiliaries of the invention are preferably used as fluxes for soldering components composed of aluminium and/or aluminium alloys, with functionalization of the surfaces of the components to be soldered together appearing at the same time as a result of the composition of the auxiliaries. The auxiliaries of the invention are also suitable as additive in aluminium production or as additive for introducing metals into aluminium for the purpose of upgrading alloys.

The preparation of the base compound alkali metal fluoroaluminate is usually carried out by reacting hydrated alumina with hydrofluoric acid to form fluoroaluminic acid in a first process step. This fluoroaluminic acid reacts in a precipitation step with an aqueous metal compound, after which the desired alkali metal salts of the complex fluorides of aluminium are precipitated.

The preparation of the auxiliaries of the invention based on alkali metal fluoroaluminates is carried out by reacting hydrated alumina (aluminium oxide trihydrate) with hydrogen fluoride in the presence of an alkali metal compound. In one embodiment of the invention, metal compounds of main groups 2 to 5 of the Periodic Table of the Elements, in particular compounds of strontium, indium, tin, antimony or bismuth, preferably in the form of their salts, in particular their halides, nitrates, carbonates or their oxides are added to the reaction mixture. In another embodiment of the invention, metal compounds of transition elements having atomic numbers from 21 up to and including 30, atomic numbers from 39 up to and including 47 and/or atomic numbers from 57 up to and including 79, preferably in the form of their salts, particularly halides, nitrates, carbonates and/or oxides, are added to the reaction mixture. Suitable compounds of the transition elements are, for example, compounds of zirconium, niobium, cerium, yttrium, or lanthanum.

The metal compounds can be introduced into the reaction system either as individual compounds or in combination with one another, e.g. in the form of mixtures. The use of metal complexes, e.g. K₂ZrF₆, K₂TiF₆ and/or mixtures of these with one another, is likewise possible.

It can be stated quite generally that all metal compounds of the main group and transition elements which are electrochemically more noble than the aluminium or aluminium alloy component to be soldered are suitable for achieving functionalization of the component surface. The functionalization of the surface is brought about by, owing to the electrochemical series, the metal ions present in the flux reacting during the melting process with the less noble surface of the component which has been activated by the flux and being reduced to the metal. This redox reaction is probably not to be regarded as of primary importance when using metal compounds of main group 2 since other effects, e.g. lowering of the surface energy, are of greater importance here.

It is likewise conceivable for the ionically bound metal to be reduced and therefore “alloyed-in” during the melting process.

For the purposes of the invention, functionalization is, for example:
alteration of the surface properties
improvement of the surface quality
improvement of the solder flow
inhibition of the growth of microorganisms The point in time when the abovementioned main group and/or transition group compounds are added can be varied. Addition can occur to the hydrogen fluoride, which is advantageous when using sparingly soluble metal compounds, or after formation of the fluoroaluminic acid, in which case the metal compounds are introduced into the mixture of hydrated alumina and hydrogen fluoride. Addition of the metal compound to the reaction mixture of hydrogen fluoride, hydrated alumina and alkali metal compound is likewise possible.

In a preferred embodiment of the invention, the metal compounds are introduced into the reaction mixture after formation of the fluoroaluminic acid and before addition of the alkali metal compound.

As alkali metal compound, use is made of alkali metal salts or alkali metal hydroxides, either as individual substances or as alkali metal salts or alkali metal hydroxide mixture in the form of their solutions or as solids, with the alkali metal preferably being lithium, sodium, potassium, rubidium or caesium, preferably potassium.

It is advantageous to add an aqueous hydrogen fluoride solution, hydrated alumina (aluminium oxide trihydrate) and main group metal compound and/or transition metal compound and then add alkali metal hydroxide, preferably potassium hydroxide. The precipitated crystalline product is separated off and dried.

The term “alkali metal fluoroaluminate” refers in particular to alkali metal tetrafluoroaluminate, alkali metal pentafluoroaluminate and alkali metal hexafluoroaluminate and also their hydrates. The alkali metal is lithium, sodium, potassium, caesium or rubidium, preferably potassium. The properties of the alkali metal fluoroaluminates as fluxes can be altered by means of combinations of alkali metals. Thus, for example, the incorporation of caesium into a potassium aluminium fluoride matrix enables the magnesium tolerance of the flux to be increased.

In a preferred embodiment, zirconium oxide, niobium oxide, lanthanum oxide, yttrium oxide or cerium oxide, for example, are introduced into the reaction mixture as metal compound. These oxides are mixed into the reaction mixture, preferably before addition of the potassium hydroxide.

In another embodiment, the metal compound is brought into contact with the initially charged hydrogen fluoride, i.e. introduced into the reaction mixture before addition of the alumina.

The metal compounds are used in amounts of up to 30% by weight, preferably from 0.01 to 20% by weight, based on the alkali metal fluoroaluminate.

The amount of metal compound added depends on the desired degree of functionalization of the surfaces as a function of the intended use.

It is possible to choose the amount of metal compounds added so that the aluminium in the flux can be replaced completely.

Depending on the time of addition of the metal compounds, e.g. the metal oxides, to the other reactants, the metals are chemically bound in the form of their metallates or are present in the form of mixture components.

It has been found that incorporation of the metal ions into the potassium aluminium fluoride crystal lattice occurs when the metal compounds are introduced into the reaction system before addition of the alkali metal compound, preferably alkali metal hydroxide, in particular potassium hydroxide.

The addition of the metal compounds as last reactant allows more physical mixtures of the potassium fluoroaluminates with partial formation of metal oxyfluorides to be formed, thus these are not as effective because they can, owing to their inhomogeneity, hygroscopic nature or differing solubility, lead to inhomogeneous surface functionalization.

Mechanical mixing of the metal compounds with the alkali metal aluminium fluorides or alkali metal fluoroaluminates is likewise possible, but very inhomogeneous elements—specifically hygroscopic mixtures having indifferent solubilities are obtained.

Variation of the proportion of the metal compounds e.g. of the proportion of oxide and combinations of the various metal compounds enables the use properties of the auxiliary according to the invention to be varied and controlled, so that a specific property profile can be set.

It has been found that when the auxiliaries of the invention are used as flux, the flux not only displays its known action, namely cleaning of the surface by removing the oxide layer, but is also able to effect a positive change in the flux activity, e.g. by influencing the viscosity and influencing the surface tension of the solder metal. For example, the smoothness of the surface can be improved.

This effect can probably be explained by the metallates incorporated into the alkali metal fluoroaluminate undergoing an electrochemical reaction with the cleaned or activated surface of the aluminium components to be soldered together during the soldering process, so that a modification of the surface (functionalization) is brought about. This functionalized surface can, in turn, effect an improvement in the solder flow (increased solder activity) a decreased roughness of the solidified flux after the soldering process or an improvement in the quality of the surface, which makes subsequent “conversion coating” unnecessary.

The flux can be applied in a manner known per se to the aluminium or aluminium alloy components to be joined, e.g. by spraying, coating or dipping, in the form of aqueous or organic suspensions.

The flux can likewise be applied by means of modem technologies such as plasma coating or high-speed spray coating to the components to be soldered together.

Dry application by means of the electrostatic spraying technology is likewise possible.

The flux can also be applied in the form of aqueous or organic suspensions, as surface coating composition or as paste to the components to be joined.

Aqueous or organic slurries advantageously contain from 10 to 75% by weight of the flux. As organic liquids, it is possible to use the substances customarily used as organic solvents, e.g. alcohols, in particular methanol, ethanol, propanol or isopropanol and also polyols. Other suitable organic liquids are, for example, pyrrolidones or ethers, e.g. diethylene glycol monobutyl ether, or ketones such as acetone, or esters of alcohols, diols or polyols.

When the flux is employed as a paste, the binders, e.g. ethylcellulose, are added to the flux.

The use of film formers, usually polymers, which are soluble in organic solvents, e.g. acetone, enables, if desired, solder metal or solder metal precursors to be applied to the workpiece simultaneously with the flux. Suitable polymers are, for example acrylates, polyvinyls, polyamines, polyenes, polyisoprenes or similar compounds having appropriately functionalized organic radicals. These organic compounds referred to as film formers are mostly vaporized during the soldering process.

As solder metal, it is possible for, for example, zinc, silicon, copper, aluminium-zinc alloys, aluminium-silicon alloys or combinations thereof or solder metal precursors such as metal hexafluorosilicate to be present in the flux or to be used.

The soldering temperature is dependent on the solder used or on the solder-forming metal. Soldering is preferably carried out above the melting point of the solder or the transformation phases of the flux or its mixture components.

Soldering below a solder metal liquidus temperature of 450° C. is by definition “soft soldering”, while soldering above this temperature is referred to as “hard soldering”. There are low-melting solders, e.g. zinc-aluminium solders, which melt at as low as 390° C. or pure zinc solder which can be used for soldering at as low as 420° C. Preference is given to carrying out soldering at from 390 to 620° C., under ambient pressure.

Flame soldering or furnace soldering, in particular under an inert atmosphere (e.g. nitrogen), are suitable processes.

The auxiliary of the invention is suitable as flux for soldering components composed of aluminium or aluminium alloys both in the presence of solder and also without additional solder, when the appropriate solder metal precursor is added.

The auxiliary of the invention can also be used for alloying of the corresponding metals into aluminium melts or aluminium alloys. Here, the metallate is reduced to the metal during melting or liquefaction of the aluminium because of the redox potential of the metallate and is thus made available as alloy former to the aluminium.

The following examples illustrate the invention without restricting its scope.

### EXAMPLE 1

### Preparation of a Functional Flux, Here: NOCOLOK® Lanthanum

| | Molar mass | | |
|---|---|---|---|
| Raw material | (g/mol) | Mass/g | Mol |
| Alumina | 78.003 | 39 | 0.5 |
| KOH | 56.105 | 72.02 | 0.57 |
| | | (44.1%) | |
| HF | 20.006 | 89.5 | 2.24 |
| | | (50.1%) | |
| Lanthanum | 325.81 | 0.85 | 0.0026 |
| oxide | | | |
| Water | | 225 | |

Procedure:

Hydrofluoric acid was placed in a suitable vessel which could be thermostated from the outside and was provided with stirrer and dropping funnel and appropriate protection against evaporation losses or hydrogen fluoride, and the hydrofluoric acid was diluted with 100 g of water.

The appropriate amount of Al(OH)₃ and additional water to control the exothermic reaction were added from the dropping funnel to this acid solution while stirring.

Lanthanum oxide was then added a little at a time, followed by the addition of the potassium hydroxide.

This reaction solution was stirred for another 30 minutes and subsequently filtered.

The filter residue was dried at 200° C. to give 71 gram of a white powder containing 0.73% of lanthanum.

Evaluation:

Differential thermal analysis (DTA), X-ray diffraction (XRD) and scanning-electron-microscopic (SEM) surface analysis were employed for the analytical characterization of the novel fluxes. The values were compared with the values of the known NOCOLOK® fluxes.

Comments on the XRD:

The XRD evaluation showed primarily the presence of the potassium-aluminium phases, KAIF₄ and “phase 1”, which are likewise known from NOCOLOK®.

Comments on the DTA:

The DAT for NOCOLOK-lanthanum showed an endothermic event (melting range) known for NOCOLOK® and a characteristic curved shape which allows analogous melting behaviour and solderability to be concluded.

### EXAMPLE 2

### Preparation of a Functional Flux, Here: NOCOLOK® Zirconium

Chemicals

| | | |
|---|---|---|
| HF, deionized 50.1% | 89.45 | g |
| Deionized dilution (dilution of HF) | 135.4 | ml |
| Al(OH)₃ hydrated alumina | 39.0 | g |
| K₂ZrF₆ | 5.86 | g |
| KOH 44.6% | 73.6 | g |
| Deionized water (dilution of KOH) | 52.56 | ml |
| Deionized water (cooling water) | 50 | ml |

Procedure

Hydrofluoric acid was weighed into a suitable vessel and diluted with 135.4 ml of deionized water. While stirring at about 170 rpm, 39 g of Al(OH)₃ were then carefully introduced into the diluted HF solution with control of the temperature. The KOH solution was subsequently added from a dropping funnel. After a reaction time of about 30 minutes, the K₂ZrF₆ was added a little at a time and the mixture was stirred for another 30 minutes. The precipitated solid was filtered off.

The filter residue was dried at 180° C. to give 77 gram of a white power containing 0.42% of zirconium.

Comments on the XRD:

This XRD evaluation showed, as in the case of the lanthanum compound of Example 1, primarily the presence of the potassium-aluminium phases, KAlF₄ and “phase 1”, which are known as NOCOLOK® phases.

Comments on the DTA:

The DAT for NOCOLOK-zirconium likewise showed an endothermic event (melting range) known for NOCOLOK®.

### EXAMPLE 3

### Preparation of a Functional Flu Here: NOCOLOK®Bismuth

Chemicals

89.3 g of HF, 50.2%

100 g of deionized water

39.0 g of Al(OH)₃ W.W.

71.5 g of KOH 44.7%

0.85 g of Bi₂O₃

80 g of cooling water

48 g of dilution water (before KOH)

Procedure

89.3g of HF were weighed into a suitable vessel and diluted with 100 g of deionized water. While stirring, 0.85 of Bi₂O₃ were added, followed by 39.0 g of Al(OH)₃ accompanied by 80 g of cooling water.

The precipitation by means of KOH to form the NOCOLOK® Bi was subsequently carried out. After an after-reaction time of 30 minutes, the precipitated solid was filtered off.

Drying at 200° C. gave 75.1 gram of a white powder having a bismuth content of 0.75 %.

Comments on the XRD:

This XRD evaluation likewise showed primarily the presence of the potassium-aluminium phases, KAlF₄ and “phase 1”, which are known as NOCOLOK® phases.

Comments on the DTA:

The DAT for NOCOLOK®-bismuth likewise showed an endothermic event (melting range) known for NOCOLOK®.

Use of the Fluxes

To obtain the results presented below, 99.9 % aluminium plates (type 3003) having dimensions of 25×25 mm at a thickness of 1 mm were coated with the appropriate new types of NOCOLOK-metallates (5 or 10 g/m²) and soldered in a laboratory furnace by the known NOCOLOK® CAB process.

SEM Surface Analysis:

Comparative surface analyses carried out after soldering showed that when NOCOLOK®-lanthanum or NOCOLOK®-zirconium were used, less roughness and crystallite formation occurred than in parts soldered using standard NOCOLOK®.

It was found that when the auxiliaries according to the invention are used as fluxes (NOCOLOK®-metallates), they produce a smoother surface and thus result in reduced infestation by microorganisms in the case of, for example, soldered capacitors. The formation of nest structures (accumulation of microorganisms) is suppressed or even prevented by the smooth surface. The growth of microorganisms is additionally inhibited or suppressed by the intrinsic cytokinetic action of the transition metal ions. A real, improved hygiene in the operation of air conditioning can be achieved as a result.

Comparative Spread Test (Activity Test):

In this test, a defined amount (5 g/m²) of the compound to be examined was placed on an aluminium sheet (type 3003) having defined dimensions (25×25 mm) and was melted in a laboratory furnace under defined and constant heating conditions (NOCOLOK® “Controlled Atmosphere Brazing” [CAB] conditions). The area over which the resolidified flux melt has spread after the soldering cycle was measured and compared.

In comparison with standard NOCOLOK®, the fluxes according to the invention (NOCOLOK®-metallates) clearly showed a quantitatively larger area of spread, which can be interpreted as improved flux activity (lower surface tension).

In practical use, this enlargement of the area of spread means that smaller amounts of the flux according to the invention are required, with functionalization of the surface to be soldered additionally being achieved, for example, in the form of metallization of the surface.

1. Noncorrosive auxiliaries for soldering aluminium and/or for upgrading aluminium alloys based on alkali metal fluoroaluminates, characterized by a content of coprecipitated metallates.

2. Noncorrosive auxiliaries according to claim 1, characterized by a content of added metallates.

3. Noncorrosive auxiliaries according to claim 1, wherein the metallates are compounds of the elements of main groups 2 to 5 of the periodic table of elements.

4. Noncorrosive auxiliaries according to claim 1, wherein the metallates are compounds of the transition elements having atomic numbers of from 21 to 30, from 39 to 47 and/or from 57 to 79 of the periodic table of elements.

5. Process for preparing noncorrosive auxiliaries for soldering aluminium and for upgrading aluminium alloys based on alkali metal fluoroaluminates, characterized in that metal compounds from the group of compounds of the elements of main groups 2 to 5 of the periodic table of elements and/or compounds of the transition elements having atomic numbers of from 21 to 30, from 39 to 47 and/or from 57 to 79 of the periodic table of elements are brought into contact with at least one of the reactants hydrated alumina, hydrogen fluoride and/or an alkali metal compound.

6. Process for preparing auxiliaries according to claim 5, characterized in that the metal compounds are used in the form of their salts, their halides, nitrates, carbonates, sulphates, borates, phosphates, or hexafluorosilicates, or their oxides, either as individual compounds, mixtures or in the form of metal complexes.

7. Process for preparing auxiliaries according to claim 5, characterized in that strontium, indium, tin, antimony and/or bismuth compounds in the form of their halides, nitrates, carbonates and/or oxides are used.

8. Process for preparing auxiliaries according to claim 5, characterized in that zirconium, niobium, cerium, lanthanum and/or yttrium compounds in the form of their halides, nitrates, carbonates and/or oxides are used.

9. Process for preparing auxiliaries according to claim 5, characterized in that lithium, sodium, potassium, rubidium and/or caesium compounds or mixtures thereof are used as alkali metal compounds.

10. Process for preparing auxiliaries according to claim 9, wherein said alkali metal compound is an alkali metal hydroxide.

11. Process for preparing auxiliaries according to claim 5, characterized in that the metal compounds are used in amounts of up to 30% by weight, based on alkali metal fluoroaluminate.

12. Process for preparing auxiliaries according to claim 5, characterized in that the metal compound is introduced into the reaction mixture of hydrated alumina and hydrogen fluoride.

13. Process for preparing auxiliaries according to claim 5, characterized in that the metal compound is introduced into the reaction mixture of hydrated alumina, hydrogen fluoride and alkali metal hydroxide.

14. Process for preparing auxiliaries according to claim 5, characterized in that the metal compound is firstly reacted with the hydrogen fluoride, after which hydrated alumina and alkali metal hydroxide are added.

15. Process for preparing auxiliaries according to claim 5, characterized in that mechanical mixing of the metal compounds with alkali metal fluoroaluminate is carried out.

16-19. (canceled)

20. Noncorrosive auxiliaries according to claim 1, wherein the metallates are strontium, indium, tin, antimony, bismuth, zirconium, niobium, cerium, lanthanum and/or yttrium.

21. Process for preparing auxiliaries according to claim 9, wherein said alkali metal compound is potassium hydroxide and the metal compound is used in amount from 0.01 to 20% by weight based on alkali metal fluoroaluminate.

22. A flux for soldering components composed of aluminium and/or aluminium alloys which comprises the auxiliary as claimed in claim 1.

23. The flux as claimed in claim 22, wherein the auxiliary is applied as aqueous or organic suspension, as surface coating composition, as paste or as dry substance.

24. An additive for upgrading alloys which comprises the auxiliary as claimed in claim 1 being used as a dry substance.

25. The flux as claimed in claim 22, wherein the flux is used for functionalizing the surfaces of the components to be soldered together.
